(19) United States
(12) Patent Application Publication
(10) Pub. No.: US 2017/0252137 A1
(43) Pub. Date: Sep. 7, 2017

(54) FULL HANDS-FREE AUTOMATIC TOOTHBRUSH

(71) Applicant: Cuong Manh Vu, HO CHI MINH (VN)

(72) Inventor: Cuong Manh Vu, HO CHI MINH (VN)

(21) Appl. No.: 15/517,513

(22) PCT Filed: Sep. 16, 2015
(86) PCT No.: PCT/IB2015/057107

§ 371 Date: Apr. 7, 2017

(30) Foreign Application Priority Data
Oct. 13, 2014 (VN) 1-2014-03412
Dec. 12, 2014 (VN) 1-2014-04142

(51) Int. Cl. A61C 17/22; A61C 17/26

(52) U.S. Cl. CPC A61C 17/228; A61C 17/26

(57) ABSTRACT

A full hands-free automatic toothbrush is disclosed for brushing all user's teeth simultaneously without holding by hands, thereby enabling the user to engage in other activities while brushing teeth, is more effective cleaning and shorten time for brushing. The full hands-free automatic toothbrush includes an jaw mould which be structured to hold the brushing bristle wires inside and can cover all the user's teeth when closing two sets of teeth. The full hands-free automatic toothbrush includes a handle which contain a source of energy and an electric motor. In some embodiments the full hands-free automatic toothbrush includes the brushing bristle wires for easy rotating around its axes and replacement. In some embodiments includes a handle for easy insertion and removal. Other embodiments include a button (two levels) or small lever (either direction) on the handle for driving bi-directional (forward and backward) to the motor.

### TECHNICAL FIELD

The invention relates to a full hands-free automatic toothbrush for brushing the whole mouth teeth simultaneously.

### BACKGROUND ART

Known the type of electric and non-electric toothbrushes which are the same shape. However, the disadvantages of these toothbrushes are the brush bristles are implanted in the toothbrush body or on cover/rods/plates/strip. So, these bristles are not easy to be replaced periodically, in the stead of that, it must be replaced the whole toothbrush. And/or when using, the bristles of these toothbrushes movement back and forth across the surface of the teeth so hard to clean the space between teeth; and/or still have to hold the handle toothbrush which are not designed removable. Specifically: 1) the patent number US 2004/0128777 A1 (Electro-motion Toothbrush) with the brush bristles are implanted directly on the body (upper and lower), when using, the body converts bristles reciprocating in opposite directions across the surface teeth. Toothbrush handle portion (not removable) that contains energy source, electric motor and drive shaft; 2) the patent number US 2013/0014332 A1 (Apparatus and Method for Brushing Teeth) with the brush bristles are implanted directly on the body (inside and outside), when using, the body is moving bristles back and forth horizontally in opposite surface of the teeth. Toothbrush handle part (removable when not brushing) contains energy storage, electric motor and gear drive system. And with docking station with power; 3) the U.S. Pat. No. 4,224,710 A (Toothbrush for the whole mouth) with the brush bristles are transplanted on to plates independently. These plates of this toothbrush are distributed throughout the body of toothbrush (top and bottom) and at an angle to the tooth surface, when using, is to play the back and forth motion of the bristles vertically by air pressure at increased time to reduce transmission from a pneumatic actuator and vacuum pumps.

### DISCLOSURE OF INVENTION

The purpose of the full hands-free automatic toothbrush is to increase convenience for user, the hands of user is free while brushing the entire surface of the teeth simultaneously, and the brushing bristles wires are replaced easily, all is more effective cleaning and shorten time for brushing.

To perform the above purpose successfully, the full hands-free automatic toothbrush comprising an jaw mould which be structured to hold the brushing bristle wires inside and can cover all the user's teeth when closing two sets of teeth. The full hands-free automatic toothbrush comprising a handle which can be disengaged from the jaw mould and contain watertightly a source of energy and an electric motor in order to drive a rotating from the electric motor to the intestine section of the jaw mould.

The different points are: the brushing bristle wires of the full hands-free automatic toothbrush are made by implanting the bristles around a stainless steel wire or a tiny cylinder-piece. These brushing bristle wires will be automatic rotating around its axes to brush user's teeth and removed easily for replacement; the edges in “fishbone” shaped with hole and socket (to hold the brushing bristle wires) can be removed and attached to the jaw mould by the sliding-trench mechanism; the walls of the outer part and the inner part of the jaw mould have the L-shaped edges to protect the axes of the brushing bristle wires from being bitten by teeth; the handle of the full hands-free automatic toothbrush is a hemispherical or rectangular block with size (small and medium) to fit the hands of users (small and large) so that user's hands can be free, no need to hold or keep the full hands-free automatic toothbrush while brushing teeth.

Because of such differences, the brushing bristles cover all the entire surface of the teeth; brush deep into the user's space between teeth simultaneously; increase efficiency of cleaning teeth and be ease of replacing the new brushing bristle wires for cost saving; and the small handle in cube-shaped so that that user's hands can be free, no need to hold or keep the full hands-free automatic toothbrush while brushing teeth.

### BRIEF DESCRIPTION OF DRAWINGS

The invention illustrated herein are presently preferred, it being understood, however, that the invention is not limited to the precise arrangements and instrumentalities shown, wherein:

FIG. 1 illustrates a top-view of the full hands-free automatic toothbrush and its parts.

FIG. 2 illustrates a top-view of the jaw mould of the full hands-free automatic toothbrush of FIG. 1.

FIG. 3 illustrates a side-view of the jaw mould of the full hands-free automatic toothbrush of FIG. 2.

FIG. 4 illustrates a cutaway side-view of the jaw mould of the full hands-free automatic toothbrush of FIG. 3.

FIG. 5 illustrates a cutaway side-view of the jaw mould of the full hands-free automatic toothbrush of FIG. 4 after fixing the brushing bristle wires and its magnified perspective view.

FIG. 6 illustrates a cutaway top-view of the jaw mould of the full hands-free automatic toothbrush of FIG. 2 after fixing the brushing bristle wires of FIG. 5, the system of cogwheels and saws, cylinders. And the magnified perspective view of the small cogwheels.

FIG. 7 illustrates a top-view of the jaw mould of the full hands-free automatic toothbrush of FIG. 2 after fixing almost the brushing bristle wires of FIG. 1 (except the brushing bristle wires of FIG. 6). And the magnified perspective view of a short brushing bristle wires, and four brushing bristle wires.

FIG. 8 illustrates a cutaway front-view of the full hands-free automatic toothbrush of FIG. 1 and a front-view with sample of molars.

FIG. 9 illustrates a cutaway side-view of the full hands-free automatic toothbrush of FIG. 1 and sample of incisors.

### DETAILED DESCRIPTION OF INVENTION

The invention according to drawings and described briefly above are described more fully detailed in this section. However, the invention is mentioned there can be expressed and understood in other ways than just limited to the drawings in this description, wherein:

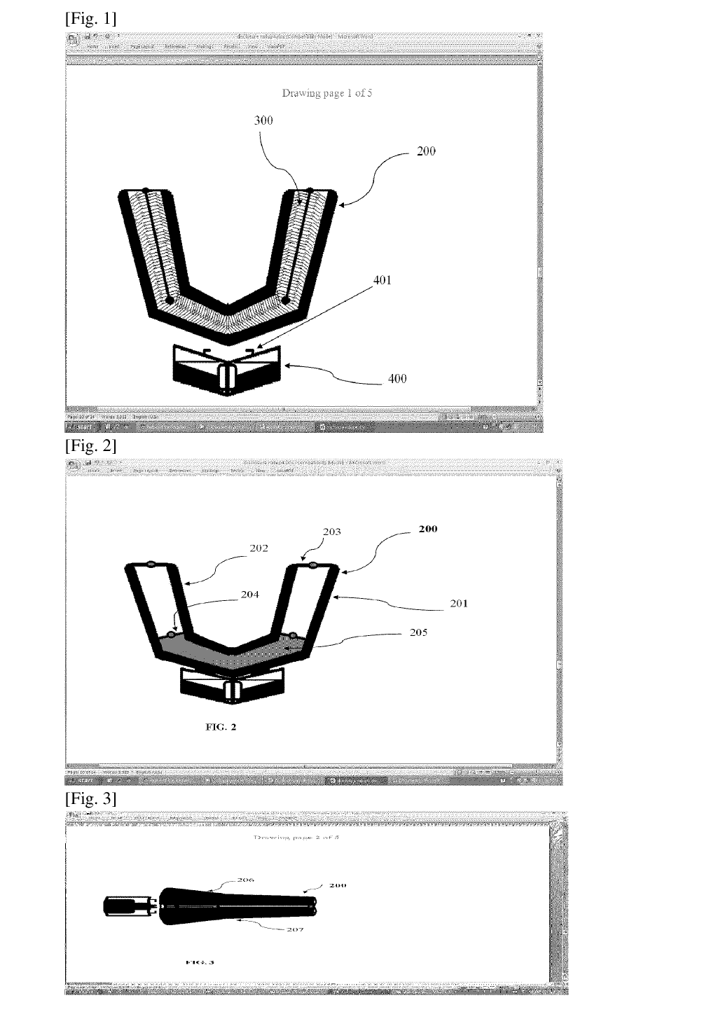

FIG. 1 illustrates one sample of the invention of a full hands-free automatic toothbrush, comprising an jaw mould 200 made from one or a combination of several materials like rubber, polyethylene, plastic, resin, silicon, wood. The jaw mould 200 with dimensions (small, medium and large) so to suit the mouth space of people (children, adolescents and adults), and be structured to hold the brushing bristle wires 300 inside which can cover all the user's teeth when closing two sets of teeth. Structure and function characteristics of the jaw mould 200 (shown in detail in FIG. 2, FIG. 3 and FIG. 4).

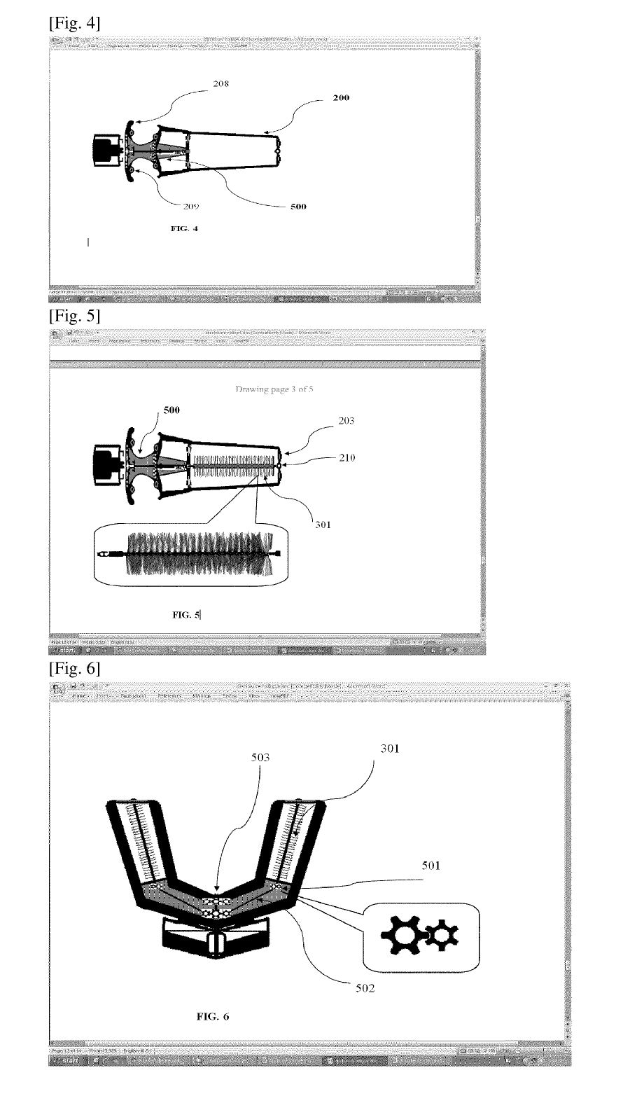

The full hands-free automatic toothbrush comprising the brushing bristle wires 300 (which can be removed and renewed periodically). The bristles of the brushing bristle wires 300 are made from at least one of the materials like flexible plastic, nylon, natural rubber, and any other material known to be used for brushing teeth. The bristles are implanted around a stainless steel wire or a tiny cylinder-piece made from one or a combination of materials like polyethylene, wood, ceramic, aluminum, and metal. The structure and characteristics of the brushing bristles wires 300 (shown in detail in FIG. 5 and FIG. 7).

FIG. 1 also illustrates one other sample of the invention of the full hands-free automatic toothbrush which may be made small in size to suit the mouth-space of children (who have fewer teeth than 24 ones). This one for children has only the brushing bristle wires 303 and 305 which all connecting it's two heads into the small cogwheels and saws system 501 (shown in detail in FIG. 6). And other parts are the same style for adults.

The full hands-free automatic toothbrush comprises a handle 400 which communicating with the bottom of the jaw mould 200 to drive a rotating from the electric motor (which was installed inside the handle 400 to the intestine section 500 of the jaw mould 200 (shown in detail in FIG. 6). The handle 400 can be disengaged from the jaw mould 200 when stop using and/or for purposes of replacing the worn parts. Shown in detail in FIG. 1, the handle 400 is fastened to or removed from the jaw mould 200 by two latches 401. The handle 400 is not limited to a specific size/form/type or to a particular structure. However, in this embodiment of FIG. 1, the handle 400 is a hemispherical or rectangular block with size (small and medium) to fit the hands of the users (small and large). The handle are made from one or a combination of plastic, wood, metal, steel, ceramic, aluminum. The handle 400 contain a source of energy (such as a small battery), an electric motor watertightly, and a button (with two levels) or small lever (with either direction) which are located on the cover of the handle 400 to drive bi-directional (forward and backward).

FIG. 2 illustrates the outer part 201 and the inner part 202 of the jaw mould 200. The two parts 201 and 202 are fixed together by the outside bridge bars 203, the inside bridge bars 204 and the two bottom flats 205.

FIG. 3 illustrates the upper part 206 and the lower part 207 of the jaw mould 200. The two sections 206 and 207 are mounted close to the other by the plastic latches or screws arranged on the outside bridge bars 203, the inside bridge bars 204 and the two bottom flats 205.

FIG. 4 illustrates the walls of the outer part 201 and the inner part 202 of the jaw mould 200 have the L-shaped edges 208 to protect the axes of the brushing bristle wires 300 from being bitten by teeth, and the pairs of edge in “fishbone” shaped with hole 209 (can be removed and attached to the jaw mould 200 by the sliding-trench mechanism for facilitating the replacement of the brushing bristle wires 300). FIG. 4 illustrates the structure of the intestine section 500 (shown in detail in FIG. 6).

FIG. 5 illustrates the two brushing bristle wires 301 with the length and diameter fitting the top surface of the last four teeth in the both of the upper and lower teeth jaws. The two brushing bristle wires 301 have a smooth head to put into the sockets 210 and a head mounted a cogwheel connecting to the small cogwheels 501 (shown in detail in FIG. 6).

FIG. 6 illustrates the intestine section 500, comprising: the big cogwheels and saws system 503 which is structured for driving to the cylinders system 502; the cylinders system 502 are structured for driving to the small cogwheels and saws system 501; and the small cogwheels and saws system 501 are structured for driving to the brushing bristle wires 300.

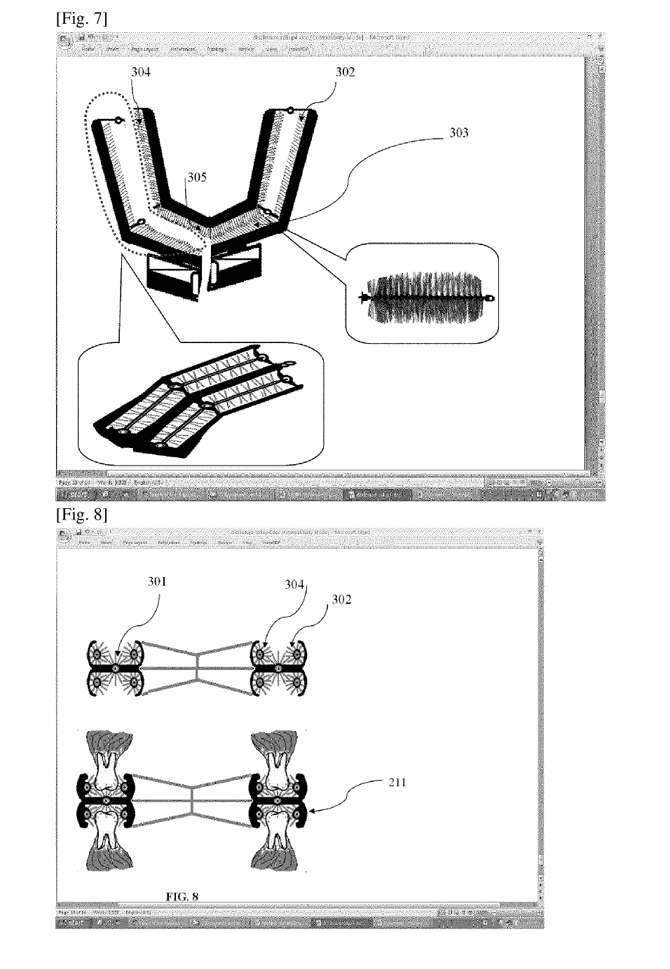

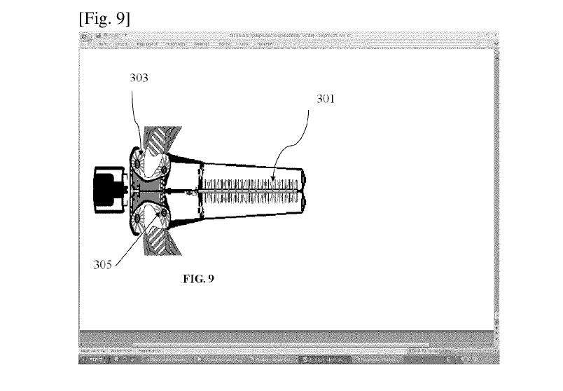

FIG. 7 illustrate:—the four brushing bristle wires 302 with the length and diameter matching the outer side surface of the last four teeth on both the upper teeth and lower teeth jaws. The four brushing bristle wires 302 have a smooth head to put into the sockets which located at the center of the “fishbone” shaped edges 211 (shown in detail in FIG. 8), and a head attached to a cogwheel to connecting to the small cogwheels and saws system 501 or connecting to the four brushing bristle wires 303;—the four brushing bristle wires 304 with the length and diameter matching the inner side surface of the last four teeth on both the upper teeth and lower teeth jaws. The four brushing bristle wires 304 have a smooth head to put into the sockets which located at the center of the “fishbone” shaped edges 211, and a head attached to a cogwheel to connecting to the small cogwheels and saws system 501 or connecting to the four brushing bristle wires 305;—the four brushing bristle wires 303 with the length and diameter matching the outer side surface of the incisors, canines and premolars on both the upper teeth and lower teeth jaws. The four brushing bristle wires 303 have a head attached to a cogwheel to connecting to the four brushing bristle wires 302 or connecting to the small cogwheels and saws system 501, and a head attached to a cogwheel to connecting to the big cogwheels and saws system 503;—the four brushing bristle wires 305 with the length and diameter matching the inner side surface of the incisors, canines and premolars on both the upper teeth and lower teeth jaws. The four brushing bristle wires 305 have a head attached to a cogwheel to connecting to the four brushing bristle wires 304 or connecting to the small cogwheels and saws system 501, and a head attached to a cogwheel to connecting to the big cogwheels and saws system 503.

FIG. 8 illustrates the brushing bristle wires 301, 302 and 304 were installed into the inside of the jaw mould 200; the “fishbone” shaped edges with socket 211 (which can be removed and attached to the jaw mould 200 by the sliding-trench mechanism) where holding the heads of the brushing bristle wires 302 and 304. And shown the location of the sample molar being brushed.

FIG. 9 illustrates the brushing bristle wires 301, 303 and 305 were installed into the inside of the jaw mould 200. And shown the location of the sample incisor being brushed.

Although various embodiments of the invention have been illustrated, it will be understood that these are no limiting examples and that the broad principles of the invention can be applied to toothbrushes differing substantially from the specific embodiments shown without departing from the spirit of this invention.

### Use the Full Hands-Free Automatic Toothbrush

Before using, the user must provide in advance an energy source for the full hands-free automatic toothbrush by charging (such as a phone charger) to charge the battery in the handle 400 or directly insert the normal batteries (such as an small battery) to the drive in the handle 400. the user at the first time of using or for purpose of replacing periodically installs the brushing bristle wires 300 into the inside of the jaw mould 200 that cover all teeth when closed the mouth. When using, the user attaches the handle 400 to the bottom of the jaw mould 200 with the latches 401. Can be used together with normal toothpaste. Then, the jaw mould 200 is put into the user's mouth, and two teeth jaws close until submerged in the brushing bristle wires 300. The user activates (turn on) the electric motor in the handle 400 by pressing a button (two levels) or small lever (either direction) which are located on the cover of the handle 400 to drive bi-directional (forward and backward) for the big cogwheels and saws system 503, the cylinders system 502 and the small cogwheels and saws system 501 in the intestine section 500. After putting the jaw mould 200 into the mouth and activating the electric motor in the handle 400, the user can take hands off the handle 400 (means the user's hands be free, no need to hold or keep the full hands-free automatic toothbrush while brushing teeth). The electric motor running will drive to operate the system of 501, 502, 503 and transmit power for making all of the brushing bristle wires 301, 302, 303, 304 and 305 turn into rotation simultaneously to brush off automatically and completely all teeth. After brushing is completed, the user removes the jaw mould 200 from mouth, turns off the electric motor and disengages the handle 400 from the jaw mould 200. The entire of the jaw mould 200 and the brushing bristle wires are easy cleaned directly under ordinary tap water. The handle 400 can be charging or replacing batteries for next time use.

1. A full hands-free automatic toothbrush comprising an jaw mould (200), the brushing bristle wires (300), a handle (400), and an intestine section (500), the different point is that this full hands-free automatic toothbrush comprising the brushing bristle wires (300) are made by implanting the bristles around a stainless steel wire or a tiny cylinder-piece, and these brushing bristle wires will be automatic rotating around its axes to brush user's teeth.

2. The full hands-free automatic toothbrush of claim 1, wherein the brushing bristle wires (300) be installed into the inside of the jaw mould (200) so as to cover all the surface of the user's teeth when closing two sets of teeth.

3. The full hands-free automatic toothbrush of claim 2, wherein the brushing bristle wires (300) can be removed from the jaw mould (200) and renewed periodically.

4. The full hands-free automatic toothbrush of claim 2, wherein the two brushing bristle wires (301), each one include one head to put into the socket (210) and another head to put into the inside bridge bar (204) connecting to the small cogwheels (501).

5. The full hands-free automatic toothbrush of claim 2, wherein the brushing bristle wires (302, 303, 304, 305), each one include one head to put into the socket of the “fishbone” shaped edge (211) and another head to put into the hole of the “fishbone” shaped edge (209) or connecting to the systems (501), (502), and (503).

6. The full hands-free automatic toothbrush of claim 5, wherein the edges (209, 211) can be removed and attached to the jaw mould (200) by the sliding-trench mechanism.

7. The full hands-free automatic toothbrush of claim 6, wherein the jaw mould (200) includes the L-shaped edges (208) to protect the axes of the brushing bristle wires (300) from being bitten by teeth.

8. The full hands-free automatic toothbrush of claim 6, wherein the jaw mould (200) include the outer part (201) and the inner part (202) are fixed together by the outside bridge bars (203), inside bridge bars (204), and two bottom flats (205).

9. The full hands-free automatic toothbrush of claim 6, wherein the jaw mould (200) include the upper part (206) and the lower part (207) are mounted close to the other by the plastic latches or screws arranged on the outside bridge bars (203), inside bridge bars (204), and two bottom flats (205).

10. The full hands-free automatic toothbrush comprising an jaw mould (200), the brushing bristle wires (300), a handle (400), and an intestine section (500), the different point is that this full hands-free automatic toothbrush comprising the handle (400) is a hemispherical or rectangular block with size (small and medium) to fit the hands of the users (small and large).

11. The full hands-free automatic toothbrush of claim 10, wherein the handle (400) is fastened to or removed from the bottom of the jaw mould (200) by two latches (401).

12. The full hands-free automatic toothbrush of claim 10, wherein the handle (400) contain a source of energy and an electric motor watertightly; and a button (two levels) or small lever (either direction) which are located on the cover of the handle (400) to driving bi-directional (forward and backward) for the systems (501), (502), and (503).
